(19) United States
(12) Patent Application Publication
(10) Pub. No.: US 2025/0225503 A1
(43) Pub. Date: Jul. 10, 2025

(54) SYSTEMS AND METHODS FOR MANAGING PHYSICAL PAYMENT CARDS

(71) Applicant: Robin Arora, Huntington, WV (US)

(72) Inventor: Robin Arora, Huntington, WV (US)

(21) Appl. No.: 18/408,551

(22) Filed: Jan. 9, 2024

(51) Int. Cl. G06Q 20/36; G06Q 20/38

(52) U.S. Cl. CPC G06Q 20/36; G06Q 20/3821; G06Q 20/389

(57) ABSTRACT

A system and method for managing physical payment cards are disclosed. The system includes a processor that is in communication with a camera. The processor is configured to receive card identification information of one or more physical payment cards associated with a user. The processor is further configured to perform an authentication check of the user once the card identification information is received. In addition, the processor is configured to convert the one or more physical payment cards into a digital wallet used for performing one or more transactions.

### FIELD

This disclosure relates to the field of payment architecture. More specifically, the field relates to a system and method for managing physical payment cards.

### BACKGROUND

Physical payment cards are tangible plastic cards issued by banks or financial institutions to facilitate electronic transactions. These cards contain information about the account holder and their associated financial account. Physical payment cards may include credit cards, debit cards, gift cards, contactless cards, and the like. Physical payment cards are widely used for in-person and online transactions, providing a convenient and widely accepted means of payment globally. They play a major role in the modern financial system, offering a secure and efficient way for individuals to access and manage their funds.

However, physical payment cards may be susceptible to theft or loss. If someone gains unauthorized access to your card, they may use it for fraudulent transactions. Fraudsters may use card skimming devices to steal card information when the physical payment card is swiped at compromised card readers, such as ATMs or gas pumps. Physical payment cards are also required to be carried by users/cardholders each time they want to make a transaction. In case the card is lost or forgotten, the user/cardholder will not be able to perform the transactions. Carrying multiple cards may sometimes be difficult for the users to manage. Further, physical payment cards have a fixed credit limit or spending limit. The credit limit refers to the maximum amount of money that a user can spend on their physical payment card and is generally set by the bank/financial institution that issued the card. However, in case of excess spending that is above the credit limit, the users would need to rely on other payment sources. This may be problematic and time-consuming from their end.

Thus, there is a need for a solution in which users may manage payments using credit cards more efficiently.

### SUMMARY

The present disclosure discloses a system for managing physical payment cards. The system includes a processor in communication with a memory. The processor is configured to receive card identification information of one or more physical payment cards associated with a user. The processor is further configured to perform an authentication check of the user once the card identification information is received. In addition, the processor is configured to convert the one or more physical payment cards into a digital wallet used for performing one or more transactions.

In accordance with the aspects of the disclosure, the authentication check of the user is performed using password authentication, multi-factor authentication, and biometric authentication.

In accordance with the aspects of the disclosure, the processor is further configured to create a metadata of the card identification information of the one or more physical payment cards associated with the user. The metadata is stored off-chain. The processor is further configured to link the metadata with an NFT on a blockchain platform. In addition, the processor is configured to generate a programmatically defined smart contract written to a distributed ledger once the NFT is created. The smart contract includes one or more custom functions that enable the metadata associated with the NFT to be changed by the user.

In accordance with the aspects of the disclosure, the processor is further configured to receive a call of at least one custom function from the user to modify the metadata to which the NFT is linked. The processor is further configured to enable the user to modify a code portion of the smart contract corresponding to the at least one custom function called by the user. In addition, the processor is configured to record and store one or more changes made to the smart contract on the distributed ledger. The one or more changes made to the smart contract each time are stored using one or more versions.

In accordance with the aspects of the disclosure, the processor is further configured to monitor a spending pattern of the user using the digital wallet. The processor is further configured to recommend one or more products for the user to purchase based on the spending pattern monitored. In addition, the processor is further configured to initiate a purchase process for the user to purchase at least one recommended product using the digital wallet.

In accordance with the aspects of the disclosure, the processor is configured to generate one or more partitions for the digital wallet. The user defines these partitions based on their financial needs and goals. The processor is further configured to allocate funds for the one or more partitions generated based on a past spending behavior of the user. The processor is further configured to monitor a spending pattern of each partition generated once the funds have been allocated. In addition, the processor is configured to generate a spending analysis report for the one or more partitions based on the spending pattern monitored.

In accordance with the aspects of the disclosure, the processor is further configured to monitor a spending pattern of the user. The processor is further configured to recommend the digital wallet suitable for the user based on the spending pattern monitored and one or more parameters. In addition, the processor is configured to receive feedback from the user based on the digital wallet recommended to them.

In accordance with the aspects of the disclosure, the processor is further configured to receive a transaction request from the user using the digital wallet. The processor is further configured to generate a token for the transaction request received. The processor is further configured to communicate the token to one or more sources for payment authentication through a payment network. In addition, the processor is configured to approve the transaction request based on the payment authentication.

In accordance with the aspects of the disclosure, the one or more physical payment cards remain unusable once converted into the digital wallet until set by the user.

The present disclosure also discloses a method for managing physical payment cards. The steps of the method may be executed by a processor in communication with a memory. The method includes receiving card identification information of one or more physical payment cards associated with a user. The method further includes performing an authentication check of the user once the card identification information is received. In addition, the method includes converting the one or more physical payment cards into a digital wallet used for performing one or more transactions.

In accordance with the aspects of the disclosure, the authentication check of the user is performed using password authentication, multi-factor authentication, and biometric authentication.

In accordance with the aspects of the disclosure, the method further includes creating a metadata of the card identification information of the one or more physical payment cards associated with the user. The metadata is stored off-chain. The method further includes linking the metadata with an NFT on a blockchain platform. In addition, the method further includes generating a programmatically defined smart contract written to a distributed ledger once the NFT is created. The smart contract includes one or more custom functions that enable the metadata associated with the NFT to be changed by the user.

In accordance with the aspects of the disclosure, the method further includes receiving a call of at least one custom function from the user to modify the metadata to which the NFT is linked. The method further includes enabling the user to modify a code portion of the smart contract corresponding to the at least one custom function called by the user. In addition, the method further includes recording and storing one or more changes made to the smart contract on the distributed ledger. The one or more changes made to the smart contract each time are stored using one or more versions.

In accordance with the aspects of the disclosure, the method further includes monitoring a spending pattern of the user using the digital wallet. The method further includes recommending one or more products for the user to purchase based on the spending pattern monitored. In addition, the method further includes initiating a purchase process for the user to purchase at least one recommended products using the digital wallet.

In accordance with the aspects of the disclosure, the method further includes generating one or more partitions for the digital wallet. The user defines these partitions based on their financial needs and goals. The method further includes allocating funds for the one or more partitions generated based on a past spending behavior of the user. The method further includes monitoring a spending pattern of each partition generated once the funds have been allocated. In addition, the method further includes generating a spending analysis report for the one or more partitions based on the spending pattern monitored.

In accordance with the aspects of the disclosure, the method further includes monitoring a spending pattern of the user. The method further includes recommending the digital wallet suitable for the user based on the spending pattern monitored and one or more parameters. In addition, the method further includes receiving feedback from the user based on the digital wallet recommended to them.

In accordance with the aspects of the disclosure, the method further includes receiving a transaction request from the user using the digital wallet. The method further includes generating a token for the transaction request received. The method further includes communicating the token to one or more sources for payment authentication through a payment network. In addition, the method further includes approving the transaction request based on the payment authentication.

In accordance with the aspects of the disclosure, the one or more physical payment cards remain unusable once converted into the digital wallet until set by the user.

The present disclosure also discloses one or more non-transitory computer-readable storage mediums storing one or more sequences of instructions. The one or more sequence of instructions is executed by a processor configured to receive card identification information of one or more physical payment cards associated with a user. The one or more processors are further configured to perform an authentication check of the user once the card identification information is received. In addition, the one or more processors are configured convert the one or more physical payment cards into a digital wallet used for performing one or more transactions.

In accordance with the aspects of the disclosure, the one or more physical payment cards remain unusable once converted into the digital wallet until set by the user.

### BRIEF DESCRIPTION OF THE DRAWINGS

FIG. 1 illustrates a block diagram of the components of a system for sharing information associated with a user according to an embodiment herein;

FIG. 2 illustrates an exploded view of the processor of FIG. 1 according to an embodiment herein;

FIG. 3 illustrates a flowchart illustrating a method for managing physical payment cards according to an embodiment herein;

FIG. 4 illustrates a flowchart illustrating a method for storing the card identification data using NFTs according to an embodiment herein;

FIG. 5 illustrates a flowchart illustrating a method for modifying the NFT to which the card identification data is linked according to an embodiment herein;

FIG. 6 illustrates a flowchart illustrating a method for recommending NFTs for purchase according to an embodiment herein;

FIG. 7 illustrates a flowchart illustrating a method for creating partitions of the digital wallet according to an embodiment herein;

FIG. 8 illustrates a flowchart illustrating a method for recommending digital wallets according to an embodiment herein;

FIG. 9 illustrates a flowchart illustrating a method for generating tokens for transactions conducted via the digital wallet according to an embodiment herein; and

FIG. 10 illustrates a schematic of an embodiment of a computer system that may be implemented to carry out the disclosed subject matter.

### DETAILED DESCRIPTION

Embodiments, of the present disclosure, will now be described with reference to the accompanying drawing.

Embodiments are provided so as to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments may not be construed to limit the scope of the present disclosure. In some embodiments, well-known processes, well-known apparatus structures, and well-known techniques are not described in detail.

The terminology used, in the present disclosure, is for the purpose of explaining a particular embodiment and such terminology may not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as requiring their performance as described or illustrated. It is also to be understood that additional or alternative steps may be employed.

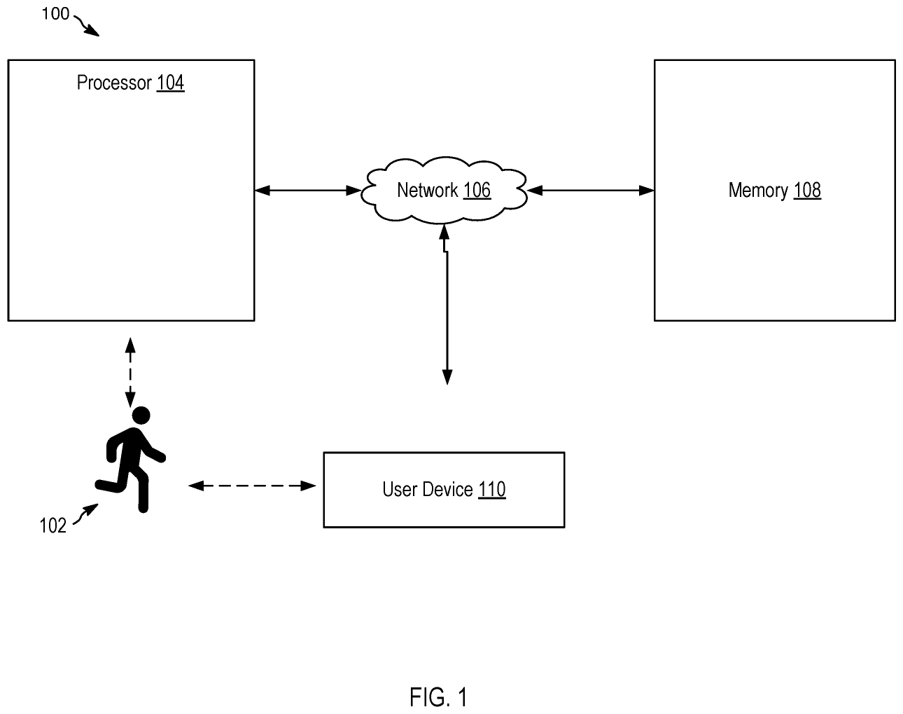

FIG. 1 illustrates a block diagram of the components of the system 100 for managing physical payment cards according to an embodiment herein. As shown, the system 100 includes a user 102, a processor 104, a network 106, a memory 108, and a user device 110 associated with a user 102. Examples of the user 102 include but are not limited to a customer, an end user, a visitor, an employee, a student, a consumer, a businessman, an organization head, a resident, a community head, a senior citizen, and the like. Examples of the physical payment cards include but are not limited to credit cards, debit cards, prepaid cards, charge cards, ATM cards, gift cards, smart cards, contactless cards, and the like. Along with physical payment cards, the system 100 may also be capable of managing virtual cards.

The processor 104 and the memory 108 are in communication with each other via the network 106. Examples of the user device 110 include but are not limited to a personal computer (PC), mobile device, smartphone, tablet, personal device assistant (PDA), cathode-ray tube (CRT), a liquid-crystal display (LCD), a light-emitting diode (LED) display, plasma, OLED, a cell phone/mobile phone display, and the like. The user device 110 presents visual representations of information communicated by the processor 104 for the user 102 to view. The user 102 has the flexibility to modify the user device 110 according to their requirements. This will thus enhance their viewing experience.

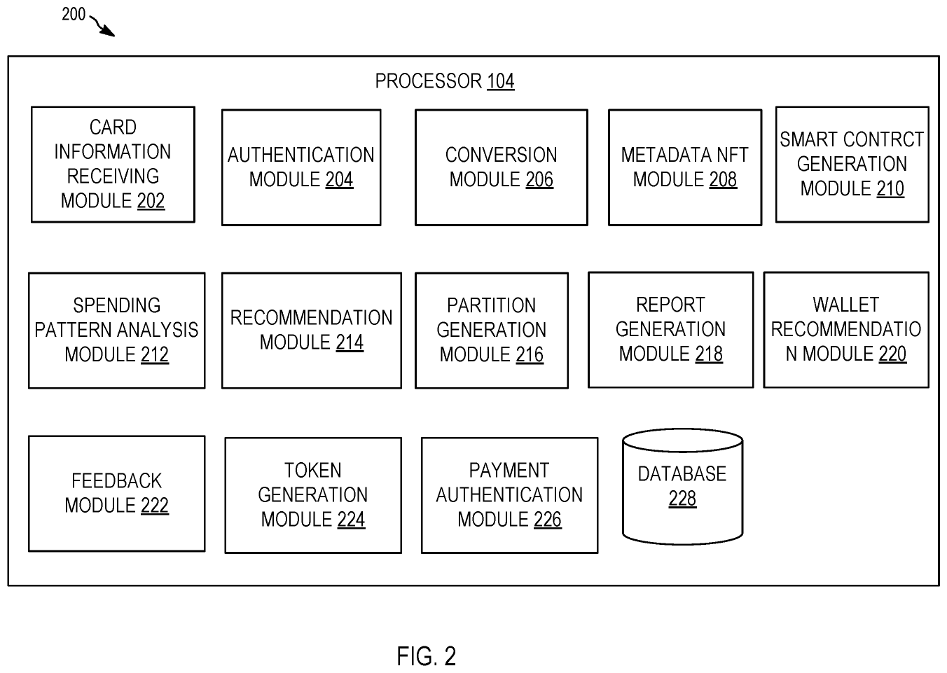

FIG. 2 illustrates an exploded view 200 of the processor 104 of FIG. 1 according to an embodiment herein. As shown, the processor 104 includes a card information receiving module 202, an authentication module 204, a conversion module 206, a metadata NFT module 208, a smart contract generation module 210, a spending pattern analysis module 212, a recommendation module 214, a partition generation module 216, a report generation module 218, a wallet recommendation module 220, a feedback module 222, a token generation module 224, a payment authentication module 226, and a database 228. The functionality of each module is explained in further detail below.

In an embodiment, the card information receiving module 202 receives card identification information of one or more physical payment cards associated with the user 102. For instance, the card identification information may be provided by the user 102 using a mobile application (digital wallet application) installed in the user device 110. In an example, the card identification information includes the physical payment card type, card number, expiration date, card verification value (CVV), and the like. The user 102 may also upload one or more photos of the physical payment card in the digital wallet application. The card identification information is stored in the database 228. Further, the user 102 may update the card identification information at any point in time. These updates are instantly stored in the database 228.

In an embodiment, the authentication module 204 perform an authentication check of the user 102 once the card identification information is received by the card information receiving module 202. For instance, the authentication check of the user 102 may be performed using password authentication, multi-factor authentication, and biometric authentication. Password authentication requires the user 102 to enter their credentials (username, password) to confirm their identity. Once the credentials are entered, they are compared against the stored credentials in the database 228, and the user 102 is granted access if the certificates match. Multi-factor authentication is a process that requires user 102 to enter more information than just a password. For example, along with the password, they might be asked to enter a code sent to their email, answer a secret question, scan a fingerprint, and the like. Biometric authentication is a process that relies on the biological characteristics of the user 102 to verify their identity. For example, the biometric authentication method may include but is not limited to facial recognition, voice recognition, fingerprint, IRIS, and the like.

In an embodiment, the conversion module 206 converts the one or more physical payment cards into a digital wallet used for performing one or more transactions. Converting the physical payment card into a digital wallet involves linking the card information to the digital wallet application. The conversion module 206 first fetches the card identification information of the user 102 stored in the database 228. The user 102 may choose which physical payment cards that they want to link with the digital wallet. Once the information is fetched, the user 102 is authenticated via the authentication module 204. Upon successful authentication, the conversion module 206 auto-submits/auto-fills the card identification information to be submitted to the digital wallet. This prevents the user 102 from manually providing the information to the digital wallet. Once the information is submitted, the one or more physical payment cards are converted to the digital wallet. Each physical payment card may have a single or individual digital wallet. Upon successful conversion, the physical payment cards remain unusable until set by the user 102. The user 102 needs to select an activation option in the digital wallet to make the physical payment card active. Thus, with the use of the digital wallet, the user 102 will be able to conduct card transactions and make contactless payments without carrying the cards with them.

In an embodiment, the metadata NFT module 208 creates a metadata of the card identification information of the one or more physical payment cards associated with the user 102. The metadata refers to data that provides information about other data. Metadata describes various attributes of a file, document, or piece of data. It offers insights into the characteristics, usage, and context of the primary data it represents. Metadata can take different forms depending on the type of information it describes. For instance, metadata may be in the form of a document, image, web, audio, video, and the like. The metadata NFT module 208 includes the NFT details about the identification information. For example, the identification information for creating the identification NFT may be in a document format or image format. The document format includes a description of the physical payment cards and the image format includes an image of the physical payment cards.

The identification NFT created by the metadata NFT module 208 is on a blockchain platform. The blockchain platform is a third-party source that is integrated with the digital wallet application. The user 102 first creates an NFT profile at the time of registration with the blockchain platform, which is installed in the user device 110. The NFT profile of the user 102 is stored in the database 228. Also, the user 102 may update their profile details at any point in time, and these changes may instantly be updated in the database 228. In an example, the NFT profile includes information such as the card identification data received by the card information receiving module 202, personal information of the user 102, title of the NFTs, description of the NFTs, royalties, biometric data of the user 102, the digital wallet information, and the like. Once the card identification data is stored within an NFT created by the metadata NFT module 208, it becomes part of a decentralized and secure ledger. This ensures that the data's integrity is maintained, and it cannot be altered without consensus from the network.

Further, the metadata is stored off-chain and not directly stored on the blockchain network. This is because blockchains are not designed to handle large amounts of data efficiently due to their decentralized and distributed nature. Storing large files on the blockchain would be expensive. Storing the metadata off-chain means that it is stored outside the blockchain on another server or storage network. The off-chain storage location may be referenced in the metadata of the identification NFT created by the metadata NFT module 208. The reference may be a URL or a hash that points to the specific location of the metadata file.

In an embodiment, the smart contract generation module 210 generates a programmatically defined smart contract written to a distributed ledger once the NFT is created by the metadata NFT module 208. The smart contract refers to one or more software programs or programming languages capable of being run and executed on the blockchain platform. In an example, the programming languages may be Solidity, viper, Yul, rust, or any other programming language known to a person skilled in the art. The smart contract(s) generated by the smart contract generation module 210 may be auto-generated.

In order to generate the smart contract, the smart contract generation module 210 first receives one or more inputs associated with the NFTs from the user 102. For instance, the one or more inputs may include variables, custom functions, access control, security considerations, and the like. The variables are declared to hold data within the smart contract. For example, the variables may include but are not limited to integers, strings, arrays, or more complex data structures. The custom functions define specific attributes or the metadata associated with the NFTs that may be changed by the user 102. In an example, the custom functions may include ‘car number’, ‘expiration data’, ‘image’, and the like. The user 102 may select the custom functions based on their needs.

Further, the access control includes details of one or more people (if any) other than the user 102 who may have access to the smart contract details. The other people may have permission to execute specific functions within the smart contract. In addition, the security considerations correspond to the security or safety of the smart contracts. Based on the one or more inputs provided by the user 102, the smart contract generation module 210 auto-generates a blockchain smart contract with a code. This code may be visible to the user 102 to view and verify. Thus, creating an identification NFT for storing the card identification information of the physical payment cards and generating a smart contract for the identification NFT created ensures that the data is securely stored.

Further, the metadata to which the identification NFT is linked may also be modified by the user 102. The user 102 is required to call at least one function (custom function) associated with a portion of the NFT that they wish to modify dynamically. For instance, if the user 102 wishes to upload another photo of their credit card, they are required to call the custom function “image’. In an example, the custom function may be ‘getImage’. Once this custom function is called, the smart contract code associated with the identification NFT is fetched from the database 228. The portion of the code in which the image details are mentioned is presented to the user 102 to modify.

Multiple versions/one or more versions of the smart contract are stored each time one or more modifications are made to the parent NFT or initial NFT. The version will be generated and saved each time the modifications are saved by the user 102. The user 102 may be charged a small transaction fee/gas fee for each dynamic modification made. Multiple versions of the smart contract code for each NFT may be stored without changing/modifying the card identification information initially stored on the blockchain platform for the parent NFT/original NFT/initial NFT. Thus, the user 102 will be able to keep a track/record of when, how, and why the modifications were made to the smart contract code for each identification NFT in the blockchain platform.

In an embodiment, the spending pattern analysis module 212 monitors a spending pattern of the user 102 using the digital wallet generated by the conversion module 206. Analyzing spending pattern corresponds to categorizing the expenses made by the user 102 using the digital wallet into different categories. The expenses may be categorized during a specific time period. In an example, the time period may be 1 month, 3 months, 6 months, 1 year, and the like. For instance, the categories may include food, entertainment, savings, education, and the like. Once categorized, the spending pattern analysis module 212 determines a total amount spend in each category within the time period, and may present the same to the user 102 on the user device 110.

In an embodiment, the recommendation module 214 recommends one or more products for the user 102 to purchase based on the spending pattern monitored by the spending pattern analysis module 212. The one or more products may be physical products, virtual products, NFTs, and the like. The recommendation module 214 segments the user 102 based on their spending pattern and preferences. The segmentation may be determined based on one or more factors, such as the categories of the products purchased by the user 102, styles that the user 102 prefers, price ranges of products purchased by the user 102 in each category categorized by the spending pattern analysis module 212, and the like. Personalized recommendations enhance the overall shopping experience by presenting with products that align closely with the interests and preferences of the user 102. Once the one or more products are recommended, a purchase process for the user 102 to purchase at least one recommended product is initiated using the digital wallet.

In an embodiment, the partition generation module 216 generates one or more partitions for the digital wallet. The user 102 may define the one or more partitions based on their financial needs and goals. In an example, the one or more partitions may be education, food, entertainment, holiday, and the like. The partitions are created for different expense categories or areas of the user 102. The user 102 may also add sub-partitions for each partition created. In an example, for the partition holiday, the sub-partitions may include domestic holidays and international holidays. Further, the one or more partitions or sub-partitions to create may also be recommended by the spending pattern analysis module 212 based on the spending pattern analyzed.

The partition generation module 216 then allocates funds to each partition. The funds may be manually allocated by the user 102 or may be recommended based on a past spending behavior analyzed by the spending pattern analysis module 212. In an example, if the user 102 is spending money on education (such as purchasing books or online courses) using the digital wallet, they may be recommended to add more funds in this partition when compared to the other partitions. The created partitions and funds allocated to each partition are then communicated to the spending pattern analysis module 212, which then monitors a spending pattern of the user 102 using each partition. The spending pattern may be monitored within a specific time period.

In an embodiment, the report generation module 218 generates a spending analysis report for the one or more partitions based on the spending pattern monitored for each partition. The spending analysis report may be in a written format, graphical format, audio format, and the like. The written format may present the spend analysis summary of the partitions in writing, the graphical format may present the spend analysis summary of the partitions in graphical format, and the audio format may present the spend analysis summary of the partitions using audio. Presenting the spend analysis summaries of each partitions in different format may help in grabbing the attention of the user 102. The spending analysis report may be helpful for the user 102 to figure out how money is being allocated across the partitions, identify patterns, and make informed decisions for budgeting and financial planning.

In an embodiment, the wallet recommendation module 220 recommends the digital wallet suitable for the user 102 based on the spending pattern monitored by the spending pattern analysis module 212 and one or more parameters. For instance, the one or more parameters may include compatibility, security features, transaction fees, reviews, and the like. The compatibility refers to whether the digital wallet is designed to work with the operating system (OS) of the user device 110. Security features correspond to the safety of the digital wallet. The combination of biometric authentication, encryption, 2FA, and other security measures helps ensure the safety of the financial data and transactions. Transaction fees are charges that may be applied when the digital wallet is used for different types of transactions or services. These fees may vary between different digital wallet providers and may impact the overall cost of using the wallet.

In an embodiment, the feedback module 222 receives feedback from the user 102 based on the digital wallet recommended to them by the wallet recommendation module 220. The user 102 may also provide feedback based on the products recommended by the recommendation module 214, the partitions recommended by the partition generation module 216, and the spending analysis report generated by the report generation module 218. The user 102 may provide their feedback in real-time using the digital wallet application. For instance, the user 102 may provide their feedback or ask queries using at least one of a voice message, verbal message, email message, and the like.

With the click of a button (not shown) on the digital wallet application, the user 102 may provide their voice message, verbal message, and email message. The term “button”, as used herein, may refer to any touch input that, when touched, causes the application to execute a command. Examples of the button include but are not limited to a mechanical button, digital button, capacitive sensing button, inductance sensing button, and holographic button. Upon clicking the button, the user 102 may provide their feedback.

For voice message, the user device 110 includes an in-built speaker and microphone, to which the user 102 may speak. Once the user 102 provides their feedback/query, the feedback module 222 first transcribes their input speech into text, extracts keywords from the transcribed text, and then uses trained data to provide a voice answer back to the user 102. For verbal messages, a chat box is presented to the user 102 on the user device 110 where they may type in their feedback/query. Here, the feedback module 222 may function as a chat bot, which is a developed program that can have conversations with people. The chatbot is trained using machine learning (ML) algorithms and is programmed to understand questions and search for the answers in a knowledge database. The chat bot may further learn from its previous and current interactions with people to develop correct answers.

In an embodiment, the token generation module 224 generates a token once a transaction request is received from the user 102 using the digital wallet generated by the conversion module 206. Instead of transmitting the actual physical payment card details (such as credit card numbers), the token generation module 224 generates a token that represents the sensitive payment data. The generated token is then linked to the specific transaction and associated with the payment card information of the user 102 securely stored in a token vault. The token is transmitted along with transaction details for processing to one or more sources for payment authentication through a payment network.

In an embodiment, the payment authentication module 226 approves the transaction request. The token is decrypted by the token generation module 224 to retrieve the original payment card information, allowing the transaction to be authorized and completed. Upon successful payment authentication, the user 102 is notified on the user device 110. Tokenization employs robust security measures to store and manage physical payment card details securely. This reduces the chances of unauthorized access to sensitive information, as the actual card data is stored in a protected token vault.

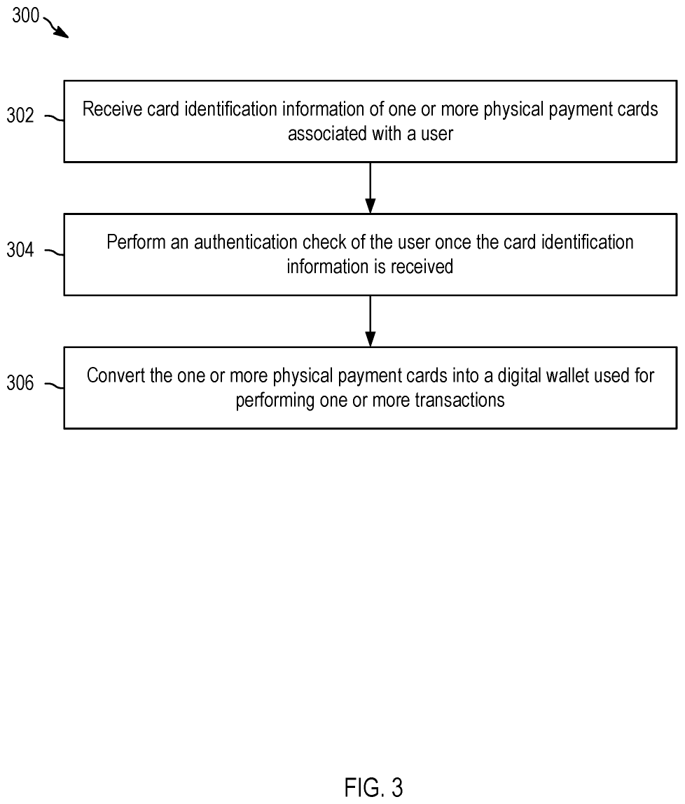

FIG. 3 illustrates a flowchart illustrating a method 300 for managing physical payment cards according to an embodiment herein. The steps 302-306 of the method 300 may be executed using the processor 104 of FIGS. 1-2. Each step is explained in further detail below.

At step 302, card identification information of one or more physical payment cards associated with the user 102 is received. For instance, the card identification information may be provided by the user 102 using a mobile application (digital wallet application) installed in the user device 110. In an example, the card identification information includes the physical payment card type, card number, expiration date, card verification value (CVV), and the like. The user 102 may also upload one or more photos of the physical payment card in the digital wallet application. The card identification information is stored in database 228, which can be updated by user 102 at any time, ensuring instant storage.

At step 304, an authentication check of the user 102 is performed once the card identification information is received in step 302. For instance, the authentication check of the user 102 may be performed using password authentication, multi-factor authentication, and biometric authentication. Password authentication is a security mechanism used to verify the identity of the user 102 by requiring them to provide a password. Once the credentials are entered, they are compared against the stored credentials in the database 228, and the user 102 is granted access if the certificates match. Multi-factor authentication (MFA) is a security process that requires the user 102 to provide multiple forms of identification before they are granted access. This approach adds an extra layer of security beyond the traditional username and password combination, making it more difficult for unauthorized individuals to gain access. For example, along with the password, they might be asked to enter a code sent to their email, answer a secret question, scan a fingerprint, and the like. Biometric authentication is a security process that uses relevant physical or behavioral characteristics to verify an identity of the user 102. For example, the biometric authentication method may include but is not limited to facial recognition, voice recognition, fingerprint, IRIS, and the like.

At step 306, the one or more physical payment cards are converted into a digital wallet used for performing one or more transactions. Converting the physical payment card into a digital wallet involves linking the card information to the digital wallet application. The card identification information of the user 102 stored in the database 228 is fetched. The user 102 may choose which physical payment cards that they want to link with the digital wallet. Once the information is fetched, the user 102 is authenticated. Upon successful authentication, the card identification information to be submitted to the digital wallet is auto-submitted/auto-filled. This prevents the user 102 from manually providing the information to the digital wallet. Once the information is submitted, the one or more physical payment cards are converted to the digital wallet. Each physical payment card may have a single or individual digital wallet. Once the conversion is accomplished, the actual physical payment cards are not accessible again until the user 102 sets them to go. If the user 102 wants to activate the actual payment card, they choose an activation option in the digital wallet. Therefore, the user 102 will be able to conduct card transactions and make contactless payments without carrying the cards with them by using the digital wallet.

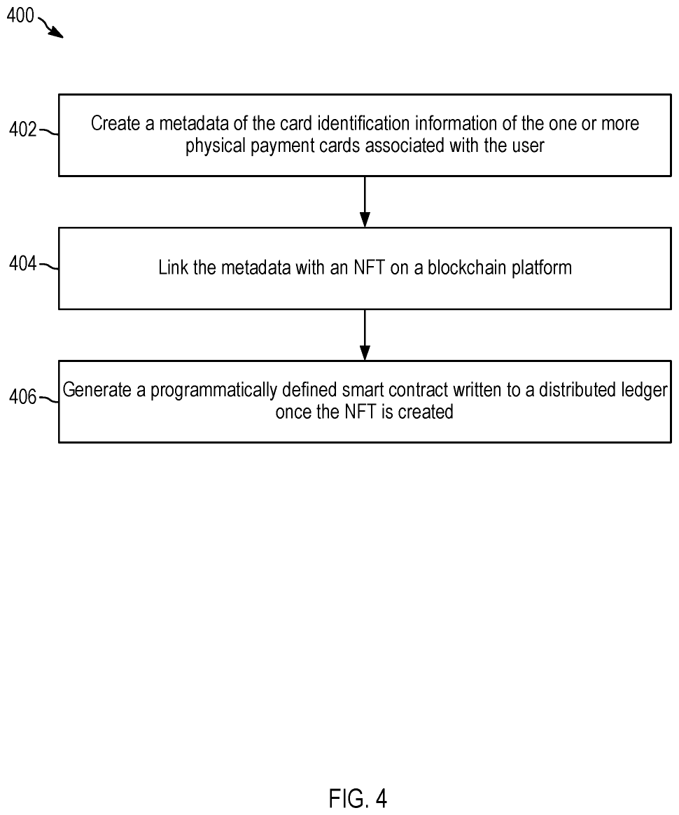

FIG. 4 illustrates a flowchart illustrating a method 400 for storing the card identification data using NFTs according to an embodiment herein. The steps 402-406 of the method 400 may be executed using the processor 104 of FIGS. 1-2. Each step is explained in further detail below.

At step 402, a metadata of the card identification information of the one or more physical payment cards associated with the user 102 is created. Data that offers details about other data is referred to as metadata. A file, document, or piece of data's numerous qualities are described via metadata. It provides information on the properties, applications, and settings of the original data it represents. The type of information that metadata describes determines the many forms that it might take. Metadata can take several forms, such as a document, image, web page, audio file, video, and so on. For instance, the identifying data needed to create the identification NFT might be stored in an image or document format. Both the picture and document formats contain an image of the actual payment cards as well as a description of them.

At step 404, the metadata created in step 402 is linked with an NFT on a blockchain platform. The blockchain platform is a third-party source that is integrated with the digital wallet application. The user 102 first creates an NFT profile at the time of registration with the blockchain platform, which is installed in the user device 110. The NFT profile of the user 102 is stored in the database 228. Further, the user 102 has the ability to modify their profile information at any moment, and the database 228 will instantly update these changes. In an example, the NFT profile includes information such as the card identification data, personal information of the user 102, title of the NFTs, description of the NFTs, royalties, biometric data of the user 102, the digital wallet information, and the like. The card identity information becomes a part of a secure, decentralized ledger once it is stored within the NFT. This guarantees the integrity of the data and prevents its alteration without the network's approval.

Furthermore, rather than being kept directly on the blockchain network, the metadata is kept off-chain. This is because, owing to their decentralized and distributed architecture, blockchains are not built to manage massive volumes of data well. It would be costly to store big files on the blockchain. The term “off-chain” refers to storing the metadata on a different server or storage network, away from the blockchain. The information of the identity NFT may contain a reference to the off-chain storage site. A hash or a URL pointing to the precise location of the metadata file can be used as the reference.

At step 406, a programmatically defined smart contract written to a distributed ledger is generated once the NFT is created. Programs or languages that can be performed and executed on the blockchain network are referred to as smart contracts. A person competent in the field may be familiar with programming languages such as Solidity, Viper, Yul, Rust, or any other language. It's possible that the smart contract or contracts that are formed are generated automatically.

In order to generate the smart contract, one or more inputs associated with the NFTs from the user 102 are received. For instance, the one or more inputs may include variables, custom functions, access control, security considerations, and the like. The variables are declared to hold data within the smart contract. For example, the variables may include but are not limited to integers, strings, arrays, or more complex data structures. The user 102 may modify some features or information associated with the NFTs, which are defined by the custom functions. In an example, the custom functions may include ‘car number’, ‘expiration data’, ‘image’, and the like. The user 102 may select the custom functions based on their needs.

Additionally, the access control contains information on one or more individuals (if any) who could have access to the smart contract details in addition to user 102. It's possible that the other parties have authorization to carry out particular smart contract operations. Furthermore, the safety or security of the smart contracts is related to the security issues. The blockchain smart contract with a code is automatically produced using one or more inputs supplied by user 102. The user 102 may be able to examine and validate this code. Thus, ensuring that the data is securely maintained is achieved by developing a smart contract for the identification NFT and building an identification NFT for keeping the card identifying information of the physical payment cards.

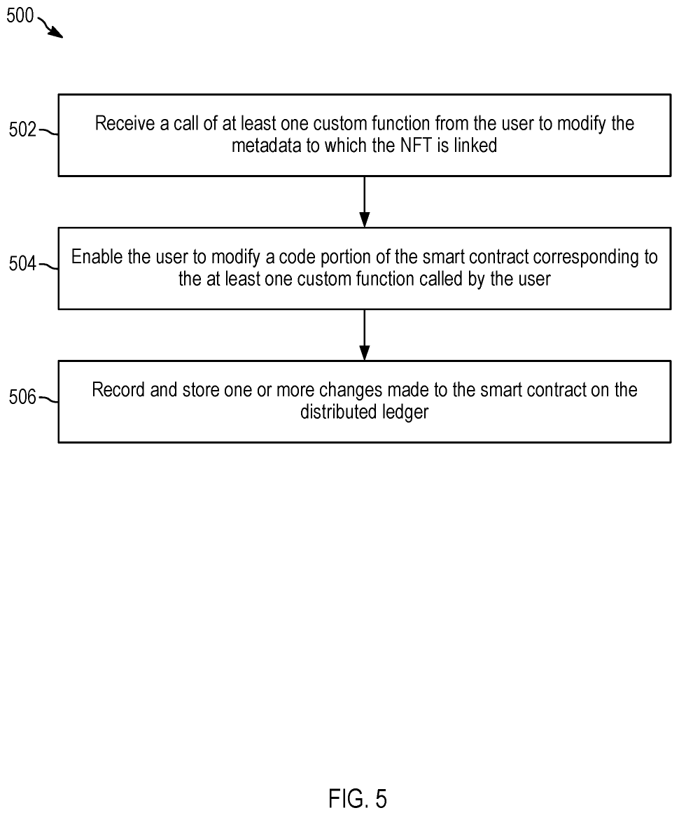

FIG. 5 illustrates a flowchart illustrating a method 500 for modifying the NFT to which the card identification data is linked according to an embodiment herein. The steps 502-506 of the method 400 may be executed using the processor 104 of FIGS. 1-2. Each step is explained in further detail below.

At step 502, a call of at least one custom function to modify the metadata to which the NFT is linked is received from the user 102. At least one function (custom function) connected to a section of the NFT that the user 102 wants to change dynamically is to be called. For example, in order for user 102 to submit an additional picture of their credit card, they call the custom function “image.” The custom function may be “getImage,” for instance. The smart contract code linked to the NFT identity is retrieved from database 228 when invoking this custom function. The user 102 is given the opportunity to edit the section of the code that mentions the picture information.

At step 504, the user 102 is enabled to change or modify a code portion of the smart contract corresponding to the at least one custom function called in step 502. For example, in order for user 102 to submit an additional picture of their credit card, they call the custom function “image.” The custom function may be “getImage,” for instance. The smart contract code associated with the identification NFT is retrieved from the database 228. It is possible for the user 102 to make changes to the code part that refers to the image information. For example, user 102 can alter the code to enhance the image quality in terms of resolution, size, clarity of color, and other aspects.

At step 506, the one or more changes/modifications made to the smart contract are recorded and stored on the distributed ledger. Each time the parent NFT or initial NFT is modified, a number of copies of the smart contract are saved. Each time the user 102 saves adjustments, a new version is created and stored. Without altering the card identifying data that was first saved on the blockchain platform for the parent NFT, original NFT, or initial NFT, multiple versions/one or more versions of the smart contract code for each NFT may be kept. For each identification NFT on the blockchain platform, the user 102 will be able to maintain a track of the when, how, and why changes were made to the smart contract code.

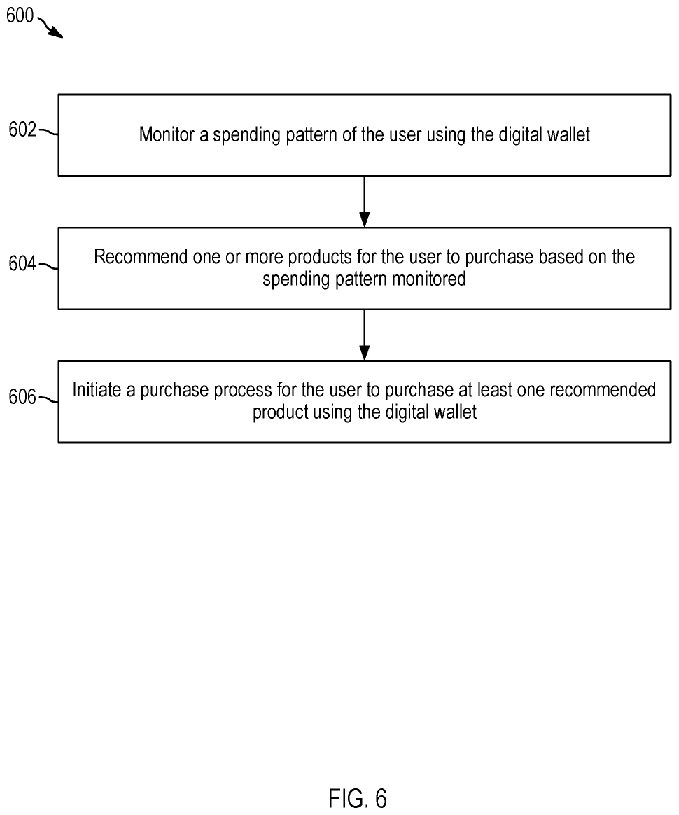

FIG. 6 illustrates a flowchart illustrating a method 600 for recommending NFTs for purchase according to an embodiment herein. The steps 602-606 of the method 600 may be executed using the processor 104 of FIGS. 1-2. Each step is explained in further detail below.

At step 602, a spending pattern of the user 102 using the digital wallet is monitored. Analyzing spending patterns entails classifying the many categories into which the digital wallet costs fall. The costs might be divided into groups according to a time frame. The time frame might be, for instance, one month, three months, six months, a year, or anything similar. Food, entertainment, money, education, and other things of that kind could be among the categories. After categorizing, the total amount spent throughout the time period in each category is calculated and may display the results to the user 102 on the user device 110.

At step 604, one or more products are recommended for the user 102 to purchase based on the spending pattern monitored. The one or more products may be physical products, virtual products, NFTs, and the like. Segmenting the user 102 according to their purchasing habits and preferences is possible. The categories of the products that the user 102 has bought, the styles that the user 102 prefers, the price ranges of the products that the user 102 has bought in each category, and other factors may be taken into consideration when determining the segmentation. By displaying goods that closely match the user 102 interests and preferences, personalized suggestions improve the overall shopping experience.

At step 606, a purchase process for the user 102 to purchase at least one recommended product in step 604 is initiated using the digital wallet. Once the purchase is successful, the user 102 is notified on the user device 110. The user 102 may be notified via SMS, email, phone call, and the like.

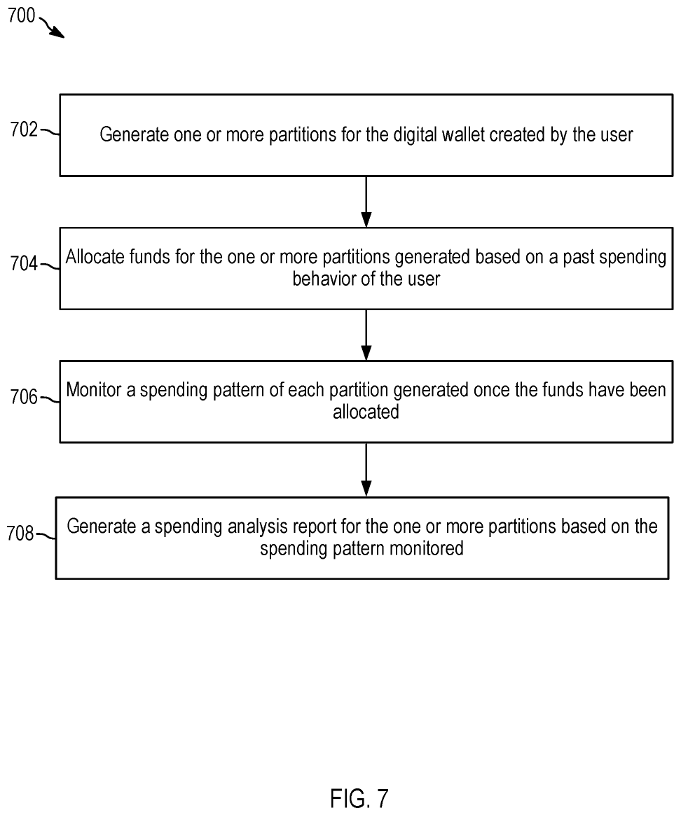

FIG. 7 illustrates a flowchart illustrating a method 700 for creating partitions of the digital wallet according to an embodiment herein. The steps 702-708 of the method 700 may be executed using the processor 104 of FIGS. 1-2. Each step is explained in further detail below.

At step 702, one or more partitions for the digital wallet are generated. The user 102 may define the one or more partitions based on their financial needs and goals. In an example, the one or more partitions may be education, food, entertainment, holiday, and the like. Partitions are made for the various regions or expenditure categories of user 102. For Each partition that is made, user 102 is also able to add sub-partitions. Domestic and foreign holidays are two possible sub-partitions for the partition holiday, for example. Furthermore, depending on the analysis of the spending pattern, the user 102 may be advised to build one or more divisions or sub-partitions.

At step 704, funds are allocated to each partition generated in step 702. The user 102 has the option to manually allocate the funds or have them recommended based on an analysis of their past spending behavior. For instance, if the user 102 uses the digital wallet to pay for educational expenses (like books or online courses), it may be suggested that they add more funds to this partition than to the other partitions.

At step 706, a spending pattern of each partition is generated once the funds have been allocated is monitored. The spending pattern may be monitored within a specific time period. In an example, the specific time period may be 1 month, 3 months, 6 months, 1 year, and the like. Understanding spending patterns may be beneficial for creating realistic budgets, identifying areas for potential savings, and making informed financial decisions. It may also help businesses tailor their products and services to meet the needs and preferences of their target market.

At step 708, a spending analysis report is generated for the one or more partitions based on the spending pattern monitored for each partition. There are one or more formats available for the spending analysis report, including textual, graphical, audio, and more. The spending analysis report of the partitions may be presented in writing in the written format, in graphical form in the graphical format, or in audio format as an audio file. The attention of the user 102 may be drawn in by presenting the spend analysis summary of each partition in a different way. The user 102 may find the spending analysis report useful in determining how funds are distributed throughout the partitions, seeing trends, and coming to well-informed financial planning and budgeting decisions.

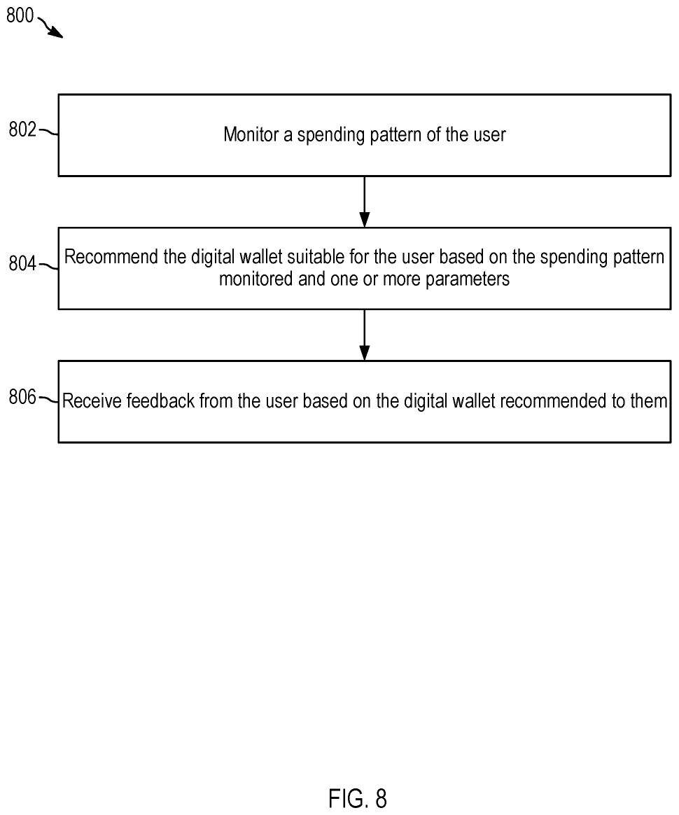

FIG. 8 illustrates a flowchart illustrating a method 800 for recommending digital wallets according to an embodiment herein. The steps 802-706 of the method 800 may be executed using the processor 104 of FIGS. 1-2. Each step is explained in further detail below.

At step 802, a spending pattern of the user 102 is monitored. Modifying a spending pattern involves making intentional changes to how financial resources are allocated. For instance, the spending pattern may be monitored based on one or more parameters, such as current spending, financial goals, a budget set by the user 102, and the like.

At step 804, the digital wallet suitable for the user 102 is recommended to the user 102. The digital wallet(s) may be recommended based on the spending pattern monitored in step 802 and one or more parameters. For instance, the one or more parameters may include compatibility, security features, transaction fees, reviews, and the like. If the operating system (OS) of the user device 110 is compatible with the digital wallet, then it is said to be compatible. Features related to security match the digital wallet's level of protection. Encryption, two-factor authentication (2FA), biometric authentication, and other security measures work together to protect financial transactions and data. Charges known as transaction fees could be incurred when specific services or transactions using the digital wallet are made. These fees might range between various providers of digital wallets and have an effect on the wallet's overall cost of use.

At step 806, feedback is received from the user 102 based on the digital wallet(s) recommended to them in step 804. The user 102 may also provide feedback based on the products recommended to them, the partitions recommended to them, and the spending analysis report generated. The user 102 may provide their feedback in real-time using the digital wallet application. For instance, the user 102 may provide their feedback or ask queries using at least one of a voice message, verbal message, email message, and the like.

With the click of a button (not shown) on the digital wallet application, the user 102 may provide their voice message, verbal message, and email message. The term “button”, as used herein, may refer to any touch input that, when touched, causes the application to execute a command. Examples of the button include but are not limited to a mechanical button, digital button, capacitive sensing button, inductance sensing button, and holographic button. Upon clicking the button, the user 102 may provide their feedback.

For voice message, the user device 110 includes an in-built speaker and microphone, to which the user 102 may speak. Once the user 102 provides their feedback/query, their input speech is transcribed into text, extracts keywords from the transcribed text, and then uses trained data to provide a voice answer back to the user 102. For verbal messages, a chat box is presented to the user 102 on the user device 110 where they may type in their feedback/query. In this case, the feedback module 222 may serve as a chat bot, which is an in-built application that is capable of carrying out human-to-person discussions. The chatbot is taught to comprehend questions and look up responses in a knowledge base using machine learning (ML) methods. To provide accurate responses, the chatbot may draw on its past and present interactions with users to learn more.

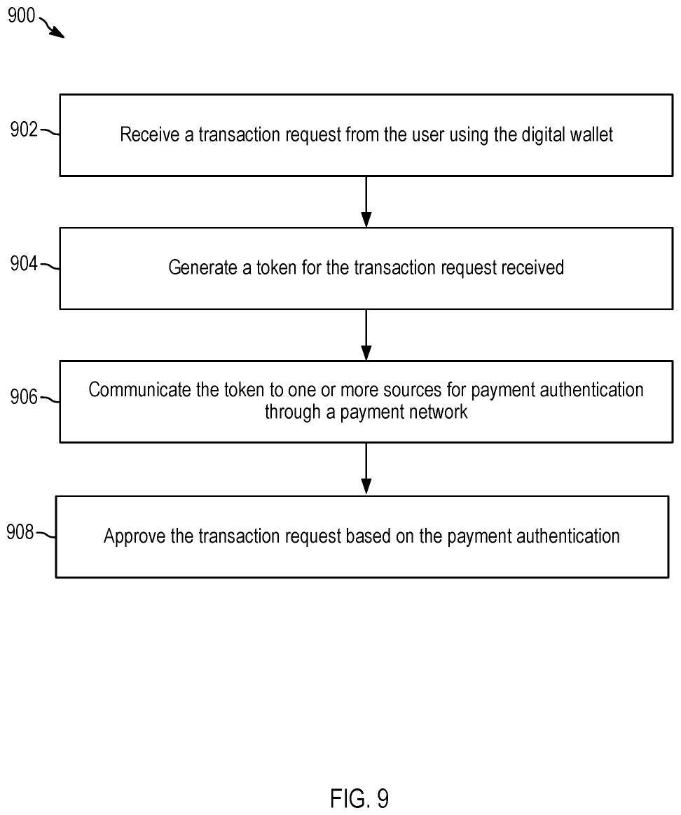

FIG. 9 illustrates a flowchart illustrating a method 900 for generating tokens for transactions conducted via the digital wallet according to an embodiment herein. The steps 902-908 of the method 900 may be executed using the processor 104 of FIGS. 1-2. Each step is explained in further detail below.

At step 902, a transaction request is received from the user 102 using the digital wallet. The transaction request refers to a formal or electronic communication initiated by the user 102 to carry out a financial transaction. Financial transactions may involve the transfer of funds, the purchase or sale of goods or services, or other actions that impact the financial state of the parties involved. In an example, the transaction request may include a payment request, a purchase request, a transfer request, an investment request, a loan/lending request, and the like.

At step 904, a token is generated for the transaction request received in step 902. Sensitive payment data is represented by the token that is produced, not the actual physical payment card details (such credit card numbers) that are transmitted. The created token is then connected to the particular transaction and linked to the credit card details of the user 102. These details are safely kept in a token vault.

At step 906, the token generated in step 904 is communicated to one or more sources for payment authentication through a payment network. A payment network is a system that facilitates the transfer of monetary value between parties. It provides the infrastructure that enables the authorization, processing, and settlement of financial transactions. Payment networks manage the flow of information and funds between the payer (the user 102) and the payee during a financial transaction. They ensure that transactions are securely and efficiently processed, taking into account factors such as authorization, authentication, and fraud prevention.

At step 908, the transaction request is approved/denied based on the payment authentication conducted in step 906. The original physical payment card details are recovered by decrypting the token, enabling the transaction to be approved and fulfilled. On the user device 110, the user 102 receives a notification upon successful payment authentication. Tokenization uses strong security protocols to safely handle and store physical credit card information. Since the physical payment card data is kept in a secured token vault, there is less danger of unwanted access to confidential data.

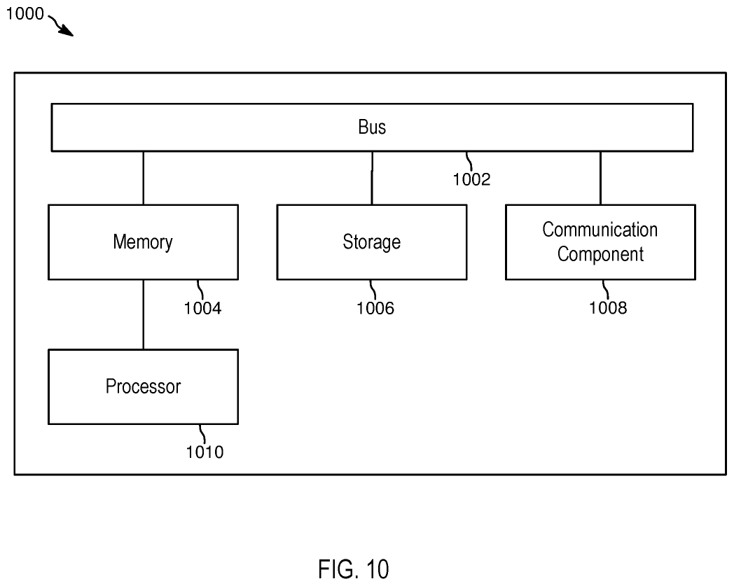

FIG. 10 is a schematic of an embodiment of a computer system 1000 that may be implemented to carry out the disclosed subject matter. As shown, the computer system 1000 includes a bus 1002, a memory 1004, a storage 1006, a communication component 1008, and a processor 1010. The bus 1002 may connect the various components of the computer system 1000. The bus 1002 may be connected to the memory 1004, which stores data that is being transmitted to the various parts of the computer system 1000 through the bus 1002. Various types of memory 1004 may be random access memory (“RAM”) and read-only memory (“ROM”). The memory 1004 may transmit instructions to the processor 1010 to be executed.

The processor 1010 may process instructions that are transmitted to the processor 1010 from the memory 1004. Executed instructions may be transmitted from the memory 1004 to the various components of the computer system 1000. Various types of processors 1010 may be central processing units (“CPUs”), graphics processing units (“GPUs”), field programmable gate arrays (“FPGAs”), complex programming logic devices (“CPLDs”), and application specific integrated circuits (“ASICs”). The processor 1010 may execute instructions that are passed to the processor 1010 by the client user.

The computer system 1000 may include a storage 1006 that holds data for indefinite periods of time. The storage 1006 may continue to hold data even when the computer system 1000 is powered down. Various types of storage 1006 are magnetic tape drives, solid state drives, and flash drives. The communication component 1008 may transmit data from the memory 1004 to and from other computer systems. For example, a communication component 1008 may connect the computer system 1000 to the internet. Alternatively, the communication component 1008 may comprise an antenna that is configured to transmit and receive data. In various embodiments, the communication component 1008 may be a Bluetooth antenna, a WIFI antenna, or the like.

The system and method described herein disclose a digital wallet application that includes multiple features. The features of the digital wallet application include converting one or more physical payment cards into a digital wallet using an automated process with minimal human intervention (card to digital wallet conversion), storing the identification data of the physical payment cards using NFTs (NFT storage), and securing the NFTs using smart contracts (NFT security). The features of the digital wallet application further include recommending one or more products for purchase based on a spending pattern analyzed using the digital wallet (recommendation feature), generate partitions and allocate funds to each partition within the digital wallet based on the financial goals of the user (partition generation feature), monitor a spending within each partition (partition spending analysis feature), receiving and providing live feedback to the digital wallet users (feedback feature), and generating tokens for transactions (token generation feature). These multiple features of the digital wallet application enable it to function as a super app.

Converting the physical payment cards into digital wallets and blocking the physical payment cards once converted prevents users in carrying cards with them while performing transactions. Storing the card identification data of each physical payment card converted into the digital wallet using NFTs is also an added advantage. Data storage using NFTs and smart contracts are secure, and minimizes possibilities of fraudsters in gaining access to the card information. Further, the digital wallet application recommends products for the users to purchase based on their spending habits using the digital wallet. This may prevent the users from analyzing their spends and future purchases by themselves, which may be time-consuming from their end. The digital wallet application also generated partitions within the digital wallet for different spending categories of the user, monitors a spending pattern for each partition, and presents an analysis report to the users. This may be helpful for the user to figure out how money is being allocated across the partitions, identify patterns, and make informed decisions for budgeting and financial planning. The users would then be aware in case of excess spending and will be prepared for this beforehand.

Further, the digital wallet application is capable of receiving feedback and providing feedback to their users via a voice message, verbal message, email message, and the like. The feedback may be provided and received in real-time. Thus, the digital wallet application is interactive and user-friendly, which is important for customer engagement and retention. As discussed above, the digital wallet application has multiple features. Having multiple features in one place prevents the users to navigate between different services or apps to obtain the required information.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and such modifications are considered to be within the scope of the present disclosure.

The embodiments herein and the various features and advantageous details thereof are explained with reference to the non-limiting embodiments in the following description. Descriptions of well-known components and processing techniques are omitted so as to not obscure the embodiments herein. The examples used herein are intended merely to facilitate an understanding of ways in which the embodiments herein may be practiced and to further enable those of skill in the art to practice the embodiments herein. Accordingly, the examples may not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications may and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

Any discussion of documents, acts, materials, devices, articles or the like that has been included in this specification is solely for the purpose of providing a context for the disclosure. It is not to be taken as an admission that any of these matters form a part of the prior art base or were common general knowledge in the field relevant to the disclosure as it existed anywhere before the priority date of this application.

The numerical values mentioned for the various physical parameters, dimensions or quantities are approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the embodiments, it will be appreciated that many embodiments can be made and that many changes can be made in the embodiments without departing from the principles of the disclosure. These and other changes in the embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system for managing physical payment cards, the system comprising:
a processor in communication with a memory, wherein the processor is configured to:
receive card identification information of one or more physical payment cards associated with a user;
perform an authentication check of the user once the card identification information is received; and
convert the one or more physical payment cards into a digital wallet used for performing one or more transactions.

2. The system as claimed in claim 1, wherein the authentication check of the user is performed using password authentication, multi-factor authentication, and biometric authentication.

3. The system as claimed in claim 1, wherein the processor is further configured to:
create a metadata of the card identification information of the one or more physical payment cards associated with the user, wherein the metadata is stored off-chain;
link the metadata with an NFT on a blockchain platform; and
generate a programmatically defined smart contract written to a distributed ledger once the NFT is created, wherein the smart contract includes one or more custom functions that enable the metadata associated with the NFT to be changed by the user.

4. The system as claimed in claim 3, wherein the processor is further configured to:
receive a call of at least one custom function from the user to modify the metadata to which the NFT is linked;
enable the user to modify a code portion of the smart contract corresponding to the at least one custom function called by the user; and
record and store one or more changes made to the smart contract on the distributed ledger, wherein the one or more changes made to the smart contract each time are stored using one or more versions.

5. The system as claimed in claim 1, wherein the processor is further configured to:
monitor a spending pattern of the user using the digital wallet;
recommend one or more products for the user to purchase based on the spending pattern monitored; and
initiate a purchase process for the user to purchase at least one recommended product using the digital wallet.

6. The system as claimed in claim 1, wherein the processor is further configured to:
generate one or more partitions for the digital wallet, wherein the user defines the one or more partitions based on their financial needs and goals;
allocate funds for the one or more partitions generated based on a past spending behavior of the user;
monitor a spending pattern of each partition generated once the funds have been allocated; and
generate a spending analysis report for the one or more partitions based on the spending pattern monitored.

7. The system as claimed in claim 1, wherein the processor is further configured to:
monitor a spending pattern of the user;
recommend the digital wallet suitable for the user based on the spending pattern monitored and one or more parameters; and
receive feedback from the user based on the digital wallet recommended to them.

8. The system as claimed in claim 1, wherein the processor is further configured to:
receive a transaction request from the user using the digital wallet;
generate a token for the transaction request received;
communicate the token to one or more sources for payment authentication through a payment network; and
approve the transaction request based on the payment authentication.

9. The system as claimed in claim 1, wherein the one or more physical payment cards remain unusable once converted into the digital wallet until set by the user.

10. A method for managing physical payment cards, the method comprising:
receiving, by a processor in communication with a memory, card identification information of one or more physical payment cards associated with a user;
performing, by the processor, an authentication check of the user once the card identification information is received; and
converting, by the processor, the one or more physical payment cards into a digital wallet used for performing one or more transactions.

11. The method as claimed in claim 10, wherein the authentication check of the user is performed using password authentication, multi-factor authentication, and biometric authentication.

12. The method as claimed in claim 10, further comprising:
creating a metadata of the card identification information of the one or more physical payment cards associated with the user, wherein the metadata is stored off-chain;
linking the metadata with an NFT on a blockchain platform; and
generating a programmatically defined smart contract written to a distributed ledger once the NFT is created, wherein the smart contract includes one or more custom functions that enable the metadata associated with the NFT to be changed by the user.

13. The method as claimed in claim 12, further comprising:
receiving a call of at least one custom function from the user to modify the metadata to which the NFT is linked;
upon the call of the at least one custom function, enabling the user to modify a code portion of the smart contract corresponding to the at least one custom function called by the user; and
recording and storing one or more changes made to the smart contract on the distributed ledger, wherein the one or more changes made to the smart contract each time are stored using one or more versions.

14. The method as claimed in claim 10, further comprising:
monitoring a spending pattern of the user using the digital wallet;
recommending one or more products for the user to purchase based on the spending pattern monitored; and
initiating a purchase process for the user to purchase at least one recommended product using the digital wallet.

15. The method as claimed in claim 10, further comprising:
generating one or more partitions for the digital wallet, wherein the user defines the one or more partitions based on their financial needs and goals;
allocating funds for the one or more partitions generated based on a past spending behavior of the user;
monitoring a spending pattern of each partition generated once the funds have been allocated; and
generating a spending analysis report for the one or more partitions based on the spending pattern monitored.

16. The method as claimed in claim 10, further comprising:
monitoring a spending pattern of the user;
recommending the digital wallet suitable for the user based on the spending pattern monitored and one or more parameters; and
receiving feedback from the user based on the digital wallet recommended to them.

17. The method as claimed in claim 10, further comprising:
receiving a transaction request from the user using the digital wallet;
generating a token for the transaction request received;
communicating the token to one or more sources for payment authentication through a payment network; and
approving the transaction request based on the payment authentication.

18. The method as claimed in claim 10, wherein the one or more physical payment cards remain unusable once converted into the digital wallet until set by the user.

19. One or more non-transitory computer-readable storage mediums storing one or more sequences of instructions, which when executed by one or more processors, causes the one or more processors to perform one or more steps of:
receiving card identification information of one or more physical payment cards associated with a user;
performing an authentication check of the user once the card identification information is received; and
converting the one or more physical payment cards into a digital wallet used for performing one or more transactions.

20. The computer-readable storage mediums as claimed in claim 19, wherein the one or more physical payment cards remain unusable once converted into the digital wallet until set by the user.
